(19) United States
(12) Patent Application Publication
(10) Pub. No.: US 2025/0103824 A1
(43) Pub. Date: Mar. 27, 2025

(54) METHOD FOR QUESTION-AND-ANSWER PROCESSING, ELECTRONIC DEVICE AND STORAGE MEDIUM

(71) Applicant: Beijing Zitiao Network Technology Co., Ltd., Beijing (CN)

(72) Inventors: Aonan TAN, Beijing (CN); Huayong DING, Beijing (CN); Jun LI, Beijing (CN); Rendan PAN, Beijing (CN); Cheng LV, Beijing (CN)

(21) Appl. No.: 18/783,342

(22) Filed: Jul. 24, 2024

(30) Foreign Application Priority Data
Sep. 22, 2023 (CN) 202311236616.4

(51) Int. Cl. G06F 40/35; G06F 3/0482; G06F 40/289

(52) U.S. Cl. CPC G06F 40/35; G06F 3/0482; G06F 40/289

(57) ABSTRACT

A method for question-and-answer processing, an electronic device and a storage medium are provided. The method includes: receiving a content of a first to-be-processed question that is inputted; acquiring at least two first answer results of the content of the first to-be-processed question, where the at least two first answer results are generated based on at least two target generative models matched with the content of the first to-be-processed question respectively, the at least two target generative models are capable of answering the first to-be-processed question, and generative models of different types are trained based on different occupational scenes; and displaying the at least two first answer results.

### CROSS-REFERENCE TO RELATED APPLICATION

This application claims the priority to and benefits of the Chinese Patent Application, No. 202311236616.4, which was filed on Sep. 22, 2023 and is hereby incorporated by reference in its entirety.

### TECHNICAL FIELD

The present disclosure relates to the technical field of computers, and specifically relates to a method for question-and-answer processing, an electronic device and a storage medium.

### BACKGROUND

With the development of artificial intelligence, the user can acquire an answer result of a consulted question through artificial intelligence, but the actual needs of the question consulted by the user is diverse, and the inputted content of the question is usually general or not very clear, so the artificial intelligence may not be able to accurately identify the actual intention of the user, resulting in that the provided answer result cannot meet the actual needs of the user, and the accuracy of the answer result is reduced.

### SUMMARY

At least one embodiment of the present disclosure provides a method for question-and-answer processing, an electronic device or a storage medium.

At least one embodiment of the present disclosure provides a method for question-and-answer processing, which includes:
receiving a content of a first to-be-processed question that is inputted;
acquiring at least two first answer results of the content of the first to-be-processed question, where the at least two first answer results are generated based on at least two target generative models matched with the content of the first to-be-processed question respectively, the at least two target generative models are capable of answering the first to-be-processed question, and generative models of different types are trained based on different occupational scenes; and
displaying the at least two first answer results.

At least one embodiment of the present disclosure further provides an apparatus for question-and-answer processing, which includes:
an input module, configured to receive a content of a first to-be-processed question that is inputted;
an acquisition module, configured to acquiring at least two first answer results of the content of the first to-be-processed question, where the at least two first answer results are generated based on at least two target generative models matched with the content of the first to-be-processed question respectively, the at least two target generative models are capable of answering the first to-be-processed question, and generative models of different types are trained based on different occupational scenes; and
a first display module, configured to display the at least two first answer results.

At least one embodiment of the present disclosure further provides an electronic device, which includes: at least one processor and at least one storage, where the at least one storage stores computer-readable instructions executable by the at least one processor; the at least one processor is configured to execute the computer-readable instructions stored in the at least one storage, the at least one processor upon executing the computer-readable instructions, implements the method for question-and-answer processing described above.

At least one embodiment of the present disclosure further provides a non-transient computer-readable storage medium, which stores computer programs, the computer programs upon being executed by at least one processor, implement the method for question-and-answer processing described above.

It is to be understood that the above general description and the following detailed description are only illustrative and explanatory, and do not limit the technical solutions of the present disclosure.

In order to make the aforementioned objects, features and advantages of the present disclosure more comprehensible, embodiments accompanied with the drawings are described in detail below.

### BRIEF DESCRIPTION OF DRAWINGS

To more clearly illustrate the embodiments of the present disclosure, the drawings required to be used for the embodiments are briefly described in the following. The drawings herein are incorporated into and form a part of the specification, illustrate embodiments consistent with the present disclosure, and are used in conjunction with the specification to explain the principles of the present disclosure. It should be understood that are only some embodiments of the present disclosure, and therefore should not be regarded as limiting the scope. For those skilled in the art, other drawings can be obtained based on these drawings without any inventive work.

FIG. 1 is a flowchart of a method for question-and-answer processing according to an embodiment of the present disclosure;

FIGS. 2A and 2B are example diagrams of a display interface of a plurality of functional cards according to an embodiment of the present disclosure;

FIG. 3 is an example diagram of a display interface of an information card of a virtual image according to an embodiment of the present disclosure;

FIG. 4 is an example diagram of a display interface of a plurality of first answer results according to an embodiment of the present disclosure;

FIG. 5 is an example diagram of selecting a first chat interface associated with dialog with a first target generative model according to an embodiment of the present disclosure;

FIG. 6 is a schematic diagram of an apparatus for question-and-answer processing according to an embodiment of the present disclosure; and

FIG. 7 is a schematic diagram of an electronic device according to an embodiment of the present disclosure.

### DETAILED DESCRIPTION

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

To make the objects, technical solutions and advantages of the present disclosure clearer, the technical solutions of the embodiments of the present disclosure will be described clearly and fully understandable in conjunction with the drawings related to the embodiments of the present disclosure. Apparently, the described embodiments are just a part but not all of the embodiments of the present disclosure. The components in the embodiments of the present disclosure generally described and illustrated in the drawings herein may be arranged and designed in various different configurations. Therefore, the following detailed description of the embodiments of the present disclosure provided in the accompanying drawings is not intended to limit the scope of the claimed disclosure, but merely represents selected embodiments of the present disclosure. Based on the described embodiments herein, those skilled in the art can obtain other embodiment(s), without any inventive work, which should be within the scope of the present disclosure.

It has been found through research that with the development of artificial intelligence, the user can acquire an answer result of a consulted question through artificial intelligence, but the actual needs of the question consulted by the user is diverse, and the inputted content of the question is usually general or not very clear, so the artificial intelligence may not be able to accurately identify the actual intention of the user, resulting in that the provided answer result cannot meet the actual needs of the user, and the accuracy of the answer result is reduced.

On the basis of the research above, the present disclosure provides a method for question-and-answer processing, including: pre-training to obtain generative models of different types based on different occupational scenes; then, after receiving the inputted content of a first to-be-processed question, acquiring at least two first answer results for the content of the first to-be-processed question, the at least two first answer results being correspondingly generated based on at least two target generative models matched with the content of the first to-be-processed question, and the target generative models being capable of answering the first to-be-processed question; and displaying the at least two first answer results. Therefore, the generative models under different occupational scenes are trained, then the content of the first to-be-processed question can be answered in match with a plurality of related generative models, so as to acquire a plurality of first answer results; and moreover, the generative models are adapted to occupational scenes with finer division of vertical categories, so that the answer results more conforming to the occupational scenes can be acquired, and the accuracy of the answer results is improved.

The defects that exist in the above solution are all the results obtained by the inventor after practice and careful study. Therefore, the discovery process of the above problems and the solutions proposed by the present disclosure for the above problems below should all be the contribution made by the inventor to the present disclosure during the process of the present disclosure.

It should be noted that like reference numbers and letters refer to like items in the following drawings, and thus, once an item is defined in one drawing, it need not be further defined or explained in subsequent drawings.

In order to facilitate the understanding of this embodiment, first a detail introduction to a method for question-and-answer processing disclosed in this embodiment of the present disclosure is provided. An execution subject of the method for question-and-answer processing according to this embodiment of the present disclosure is generally an electronic device with computing power, the electronic device includes, for example: a terminal device or a server or other processing device; the terminal device may be a user equipment (UE), a mobile device, a cellular phone, a cordless phone, a personal digital assistant (PDA), a handheld device, a computing device, a vehicle-mounted device, wearable devices, etc.; the PDA is a handheld electronic device that has some functions of an electronic computer and can be used for managing personal information, browse the Internet, send and receive emails, etc., generally not equipped with a keyboard, can also be called a handheld computer. In some possible embodiments, the method for question-and-answer processing can be implemented by a processor calling computer-readable instructions stored in a memory.

The method for question-and-answer processing according to the embodiment of the present disclosure is described below by taking the terminal device serving as the execution body as an example.

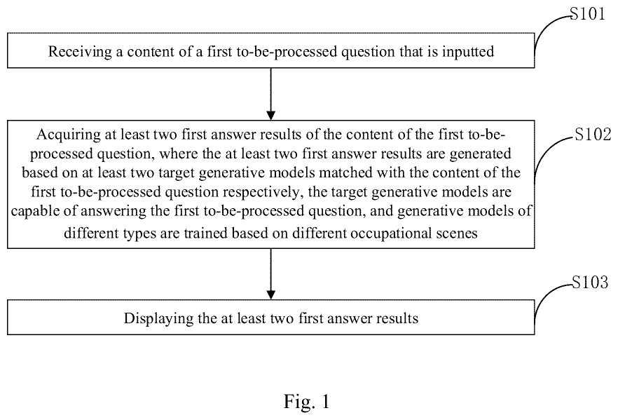

FIG. 1 is a flowchart of a method for question-and-answer processing according to an embodiment of the present disclosure, and the method includes:

S101: receiving a content of a first to-be-processed question that is inputted.

In this embodiment of the present disclosure, the method can be applied to artificial intelligence question and answer in any scene; and there is no restriction on the intention of the content of the first to-be-processed question that is inputted, for example, it can be to generate a panting, copywriting creation, text rewriting, etc.

Moreover, in this embodiment of the present disclosure, different occupational scenes can be divided into more vertical categories; different generative models are correspondingly trained for different occupational scenes; moreover, when users ask questions, they may not be sure at first which occupational scene they want to consult, or they may not be sure which occupational scene they can get better answer. In order to better meet the different needs of the users, in this embodiment of the present disclosure, a corresponding generative model may also be obtained by training for a comprehensive occupational scene; and the comprehensive occupational scene may also be understood as not distinguishing specific occupational scenes, not distinguishing training samples for occupational scenes during training, but based on training samples for a plurality of occupational scenes during training.

Further, in this embodiment of the present disclosure, virtual images or tools and the like associated with different occupational scenes may also be displayed, so that the users can select different tools to ask questions as required; and moreover, in this embodiment of the present disclosure, a plurality of answer results can be returned for the questions asked in the comprehensive occupational scenes; and for the input of the content of the first to-be-processed question, the present disclosure further provides several possible implementation modes as follows.

1) Displaying a plurality of virtual images respectively representing the generative models of different types, where the plurality of virtual images are related to occupational scenes associated with the generative models.

In response to a selection operation for a first virtual image among the plurality of virtual images, displaying a second chat interface associated with the first virtual image, and receiving the content of the first to-be-processed question that is inputted in the second chat interface, where the first virtual image is associated with a generative model trained based on a comprehensive occupational scene.

For example, virtual images associated with occupational scenes of vertical categories such as an author and an artist, as well as the first virtual image associated with the comprehensive occupational scene are displayed, so that the user can select the first virtual image and enter the second chat interface associated with the first virtual image, and can chat with the first virtual image in the second chat interface.

2) In response to the selection operation for the first virtual image among the plurality of virtual images, highlighting the first virtual image, and in response to an input instruction, receiving the content of the first to-be-processed question that is inputted.

For example, after the user selects the first virtual image, the user can input the content of the first to-be-processed question in a voice mode and the like without jumping to display the second chat page associated with the first virtual image, and then can jump to display the second chat page after inputting the content of the first to-be-processed question, and an answer result is displayed on the second chat page.

S102: acquiring at least two first answer results of the content of the first to-be-processed question, where the at least two first answer results are generated based on at least two target generative models matched with the content of the first to-be-processed question respectively, the target generative models are capable of answering the first to-be-processed question, and generative models of different types are trained based on different occupational scenes.

In this embodiment of the present disclosure, a specific implementation mode is provided for the mode of determining the target generative models and includes:

1) Performing intention recognition on the content of the first to-be-processed question and obtaining a target intention category of the content of the first to-be-processed question, where the target intention category represents an intention category of an occupational scene required for answering the first to-be-processed question.

For example, the user selects the personal assistant, and ask a question for the personal assistant by inputting the content of the first to-be-processed question, and the content of the first to-be-processed question is, for example, helping me to formulate a scientific fat reduction recipe; and intention recognition can be carried out on the content of the first to-be-processed question based on an intention recognition model, so as to judge which occupational scene can provide more professional and accurate answer for the content of the first to-be-processed question.

2) According to the target intention category and occupational scene feature information associated with the generative models, matching the target intention category with each piece of occupational scene feature information, and determining the target generative model which meets a similarity condition from the generative models.

For example, two target generative models meeting the similarity condition are determined by matching the occupational scene feature information with the target intention category, such as target generative models corresponding to a nutritionist and a doctor.

In addition, in this embodiment of the present disclosure, the user first selects the comprehensive occupational scene and then asks a question, so the finally matched target generative model further includes the generative model corresponding to the comprehensive occupational scene. Furthermore, in this embodiment of the present disclosure, based on a plurality of target generative models, a plurality of first answer results can be obtained for the content of the first to-be-processed question, for example, three first answer results may be obtained, including: an answer from the comprehensive occupational scene, an answer from perspective of the nutritionist and an answer from perspective of the doctor.

S103: displaying the at least two first answer results.

In this embodiment of the present disclosure, for S103 of displaying the at least two first answer results, a possible implementation mode is provided as follows:

1) Displaying label identifiers respectively representing the at least two target generative models.

The label identifiers may be occupation names under occupational scenes corresponding to the target generative models, and may also be virtual images and the like correspondingly set for different occupational scenes, which is not limited here.

2) For each label identifier of the label identifiers, a display card corresponding to the label identifier is used for displaying a first answer result generated by a target generative model corresponding to the label identifier.

In this embodiment of the present disclosure, the display cards of the label identifiers of the plurality of target generative models may be displayed in a combination form for displaying, which is not limited here; and different first answer results are correspondingly displayed in each display card.

3) In response to a switching operation for a first label identifier among the label identifiers, switching to display a first answer result generated by a target generative model corresponding to the first label identifier. The first label identifier refers to any label identifier among the label identifiers.

In this embodiment of the present disclosure, different occupational scenes are divided, and corresponding generative models are trained for the different occupational scenes. Therefore, when the user asking questions, the inputted content of the first to-be-processed question can be received; at least two first answer results can be generated based on the at least two target generative models matched with the content of the first to-be-processed question, and then the at least two first answer results can be acquired and displayed. Therefore, in a single question-and-answer dialog, a plurality of first answer results of the generative models based on different occupational scenes can be obtained, namely, the first answer results which are of more vertical categories and conform to the different occupational scenes can be obtained, the answer results are more professional, the accuracy of the answer results is improved, the answer experience of the user is also improved, and the professional perception of artificial intelligence is enhanced.

Further, in this embodiment of the present disclosure, when displaying at least two first answer results for the content of the first to-be-processed question, the first answer results may be adjusted or a subsequent in-depth dialog may be carried out based on the first answer results in this embodiment of the present disclosure, specifically, the present disclosure further provides a possible implementation mode.

In one possible implementation mode, when displaying the at least two first answer results, the method further includes:

1) For any first answer result, displaying question prompt information associated with the first answer result.

The question prompt information may be generated based on the content of the first answer result, and may also be generated by combining the content of the first answer result, associated hot question information and the like, which is not limited in this embodiment of the present disclosure.

For example, the first answer result is a healthy recipe suggestion, such as breakfast: milk, eggs and the like; and the question prompt information may be: do not want to drink milk, add fruits to the recipe and the like.

2) In response to a selection operation for the question prompt information, acquiring an adjusted first answer result, and displaying the adjusted first answer result, where the adjusted first answer result is obtained by a target generative model corresponding to the first answer result adjusting the first answer result according to the question prompt information selected.

For example, if the question prompt information selected by the user is: do not want to drink milk, the target generative model can adjust the healthy recipe suggestion in the first answer result, and milk is removed from the recipe, for example, the adjusted first answer result includes breakfast: soybean milk, eggs and the like.

Therefore, in this embodiment of the present disclosure, related question prompt information may be displayed for the user to select, and the first answer result is adjusted, so that the adjustment efficiency is improved, the user requirements are better met, and the accuracy and the user experience are improved.

In a possible embodiment, after displaying the at least two first answer results, the method further includes:

1) In response to a dialogue instruction of a first target generative model selected from the at least two target generative models, jumping to display a first chat interface associated with the first target generative model.

For example, the first answer results under three occupational scenes are displayed and are corresponding to the comprehensive occupational scene (personal assistant), the nutritionist and the doctor; and when the user wants to get further chat and communication with the nutritionist, an instruction of dialoging with the nutritionist can be triggered, namely the first chat interface associated with the nutritionist can be displayed.

2) Receiving a content of a second to-be-processed question that is inputted in the first chat interface.

3) Acquiring a second answer result for the content of the second to-be-processed question, where the second answer result is generated by the first target generative model performing semantic analysis based on an occupational scene guide language associated with the first target generative model and the content of the second to-be-processed question.

The occupational scene guide language is used for indicating to answer the question under the associated occupational scene, and may include an answer requirement, an answer sample and the like under the occupational scene; and the occupational scene guide language may be preset and continuously updated in this embodiment of the present disclosure.

Therefore, in this embodiment of the present disclosure, after the first answer result is displayed, any occupational scene can be selected to for further in-depth dialog, and the selected occupational scene can be continued in subsequent question-and-answer dialog, so that the answer accuracy is improved.

In addition, in this embodiment of the present disclosure, it also supports the display of historical question and answer information, so the user can quickly find and acquire the answered information; in order to further improve the display effect, when displaying historical answer information, it can be combined with the display of virtual images associated with different professional scenes to display a form of a plurality of functional cards combined, specifically, the present disclosure provides a possible implementation mode as follows.

1) In a form of a plurality of functional cards combined, displaying the plurality of functional cards, where the plurality of functional cards are used for displaying corresponding functional information respectively.

2) In response to a switching operation for a first functional card among the plurality of functional cards, switching to display functional information corresponding to the first functional card, where the functional card includes a historical dialog functional card and a question asking functional card, the historical dialog functional card displays historical question-and-answer information, and the question asking functional card displays the plurality of virtual images. The first functional card refers to any functional card among the plurality of functional cards.

Therefore, in this embodiment of the present disclosure, the user can switch to different functional cards to view the corresponding functional information, so that the operation efficiency is improved.

Further, when switching to the question asking functional cards, virtual images associated with a plurality of different occupational scenes may be displayed, and the occupational names of the occupational scenes corresponding to the virtual images may be displayed, for example, nutritionist, teacher, doctor, writer, and personal assistant are displayed; the division and definition of the occupational scenes and the occupational names may be preset; however, the users may not be familiar with some occupational names, and do not know which answer they can get. Therefore, in this embodiment of the present disclosure, in order to further improve the user experience, detail introduction information of each occupational name may be provided. Specifically, the present disclosure provides a possible implementation mode: in response to a detail introduction view operation for any virtual image in the plurality virtual images, displaying an information card of the virtual image, and displaying detail introduction information of the virtual image in the information card.

Then the users can know which question each virtual image can answer based on the detail introduction information. If the users can determine to ask which visual image corresponding to a professional scene, they can select the occupational scene of a specific vertical category to ask a question instead of choosing the personal assistant (comprehensive occupational scene). When selecting the virtual image of the occupational scene of a specific vertical category, it can only display the answer result for the occupational scene of the specific vertical category, specifically, the present disclosure provides a possible implementation mode as follows.

1) In response to a selection operation for a second virtual image among the plurality of virtual images, displaying a third chat interface associated with the second virtual image, and receiving the content of a third to-be-processed question inputted in the third chat interface, where the second virtual image is associated with a generative model trained based on an occupational scene.

2) Acquiring a third answer result for the content of the third to-be-processed question, where the third answer result is generated by the generative model associated with the second virtual image.

3) Displaying the third answer result in the third chat interface.

For example, if the selected second virtual image is the nutritionist, the third chat interface associated with the nutritionist may be displayed; questions and dialogs in the third chat interface are all answered based on the generative model trained corresponding to the nutritionist, and the answer result is more conforming to the occupational scene of the nutritionist, so that the answer accuracy and professionality are improved, and the user experience is optimized.

The following adopts specific application scenes to illustrate the method for question-and-answer processing according to the embodiment of the present disclosure.

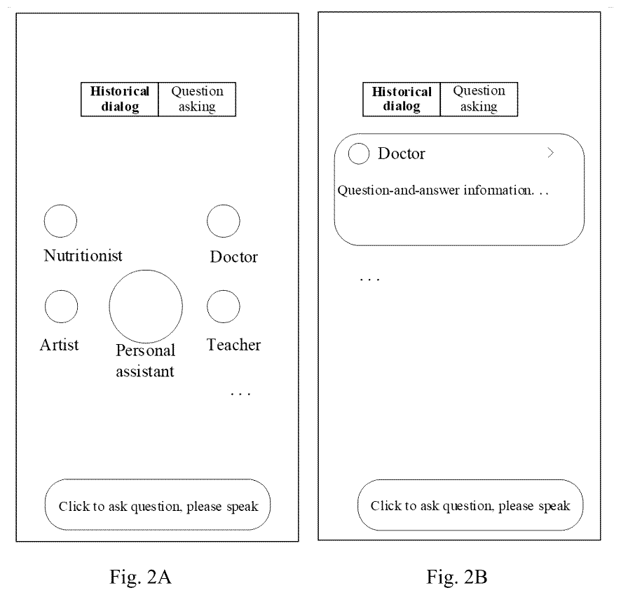

1) FIG. 2 is an example diagram of a display interface of a plurality of functional cards according to an embodiment of the present disclosure. Taking the functional cards including the historical dialogue functional card and the question asking functional card as an example, as shown in (1) in FIG. 2, under the condition of switching to the question asking functional card, each virtual image and corresponding occupation name are displayed in the question asking functional card. In order to improve the display effect, the virtual images may be preset in a manner of fitting corresponding occupational scenes; the specific form of the virtual images is not shown in FIG. 2. In addition, the names of the virtual images may be displayed without limitation, for example, personal assistant, nutritionist, doctor, artist, and teacher are displayed. The personal assistant corresponds to the comprehensive occupational scene, which is not specific to the occupational scene of a specific vertical category, and can be understood to be obtained by training for a plurality of occupational scenes; and other occupation names are obtained by training in association with a certain occupational scene.

As shown in (2) in FIG. 2, under the condition of switching to the historical dialogue functional card, historical question-and-answer information is displayed in the historical dialogue functional card. For example, when the historical question-and-answer information is displayed, the virtual image that gives the answer, the question, and the answer may be displayed; furthermore, a plurality of pieces of historical question-and-answer information may be displayed in a card form. Part of information may be displayed on the card in advance, and the user can click a card to view all historical question-and-answer information.

2) The users can click the occupation name corresponding to the virtual image when the virtual image is displayed in FIG. 2, so as to view detail introduction information, and can also click a chat interface for a certain virtual image subsequently to view the detail introduction information and the like, which is not limited in this embodiment of the present disclosure.

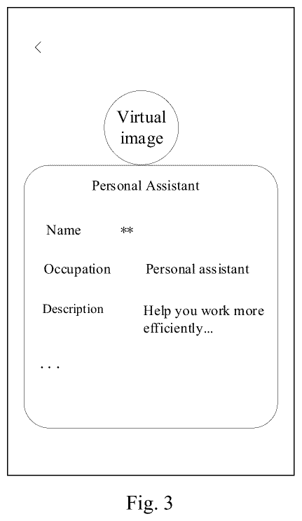

For example, FIG. 3 is an example diagram of a display interface of an information card of a virtual image according to an embodiment of the present disclosure. Under the operation of viewing the detail introduction of the personal assistant, the information card of the personal assistant is displayed, and the information card displays the detail introduction information of the personal assistant, for example, name, occupational title, and description information, or interest and hobby, education degree and the like, which is not limited in this embodiment of the present disclosure, thus more personification can be achieved, and the use experience of the users is improved.

3) Further, the user can select one of the displayed virtual images to ask questions according to requirements; and if the user cannot determine which virtual image corresponding to an occupational scene of a specific vertical category can provide a better answer effect or wants to view and combine the answers under a plurality of occupational scenes, the personal assistant can be selected for asking question.

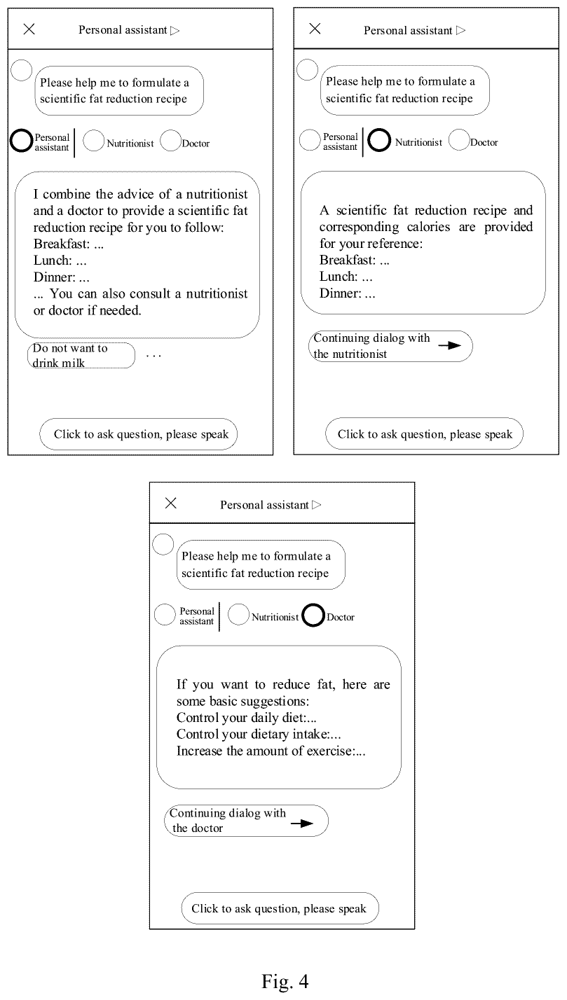

In this embodiment of the present invention, if the personal assistant is selected, or the user does not select any virtual image, but directly triggers to input the content of the first to-be-processed question, the personal assistant can be selected by default, and the plurality of corresponding first answer results can be returned and displayed. For example, FIG. 4 is an example diagram of a display interface of a plurality of first answer results according to an embodiment of the present disclosure, for example, the content of the first to-be-processed question is: please help me to formulate a scientific fat reduction recipe. By performing intention recognition on the first to-be-processed question, the target intention category can be obtained, and according to the target intention category, a matched target generative model that can give answer for the content of the first processing question can be determined. Because the personal assistant is selected, the matched target generative model includes the generative model of the comprehensive occupational scene corresponding to the personal assistant. In addition, the generative model of the occupational scene of a specific vertical category can be obtained through matching, for example, generative models corresponding to nutritionist and doctor are further included. As shown in FIG. 4, three first answer results are displayed, including the first answer result under the comprehensive occupational scene, the first answer result under the nutritionist occupational scene and the first answer result under the doctor occupational scene respectively.

Furthermore, in this embodiment of the present disclosure, the first answer results under different occupational scenes may be viewed through switching. As shown in FIG. 4, the three first answer results are displayed in a card combination form; and the corresponding first answer results can be switched and displayed by clicking the label identifier of a target generative model.

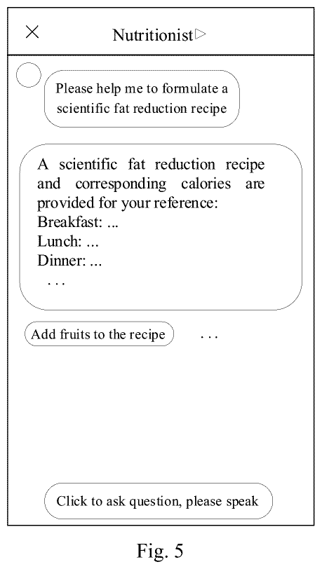

Further, in this embodiment of the present disclosure, for displayed first answer results of a plurality of target generative models, any one of the first target generative models can be selected for continuous dialog. For example, as shown in FIG. 4, a control of continuing dialog with a nutritionist is clicked, an instruction for continuing dialog with the nutritionist is inputted, then it can jump to display the first chat interface associated with the nutritionist. FIG. 5 is an example diagram of selecting a first chat interface associated with dialog with a first target generative model according to an embodiment of the present disclosure. As shown in FIG. 5, the first chat interface associated with the nutritionist is displayed; in order to facilitate understanding and viewing of the user, previous dialog content can be displayed in the first chat interface, that is, the content of the first to-be-processed question that is inputted previously and the first answer result of the nutritionist in FIG. 5, so that the user can continue to ask questions with the nutritionist in the first chat interface, questions can be inputted through voice or manual operation, which is not limited. And the questions inputted in the first chat interface are answered based on the target generative model corresponding to the nutritionist.

In this embodiment of the present disclosure, the generative models corresponding to different occupational scenes are provided; and a plurality of generative models can be automatically called for answering through intention recognition during a natural dialog, and a plurality of related answering results can be generated, thus the answer diversity and richness are improved, the user question asking requirements are better met, and the user can select any one of the occupational scenes to carry out in-depth dialog.

It is to be noted that the interface example diagram in this embodiment of the present disclosure is only a possible example and should not be limited to the embodiment of the present disclosure.

It can be understood by those skilled in the art that in the above-mentioned method of specific embodiments, the writing order of each step does not mean strict execution order and constitutes any limitation on the implementation process, and the specific execution order of each step should be determined according to its function and possible internal logic.

Based on the same invention conception, an embodiment of the present disclosure also provides an apparatus for question-and-answer processing corresponding to the method for question-and-answer processing, and because the principle of the apparatus solving the problem in this embodiment of the present disclosure is similar to the method for question-and-answer processing described above in the embodiment of the present disclosure, the embodiments of the apparatus can refer to the embodiments of the method, which will not be repeated here.

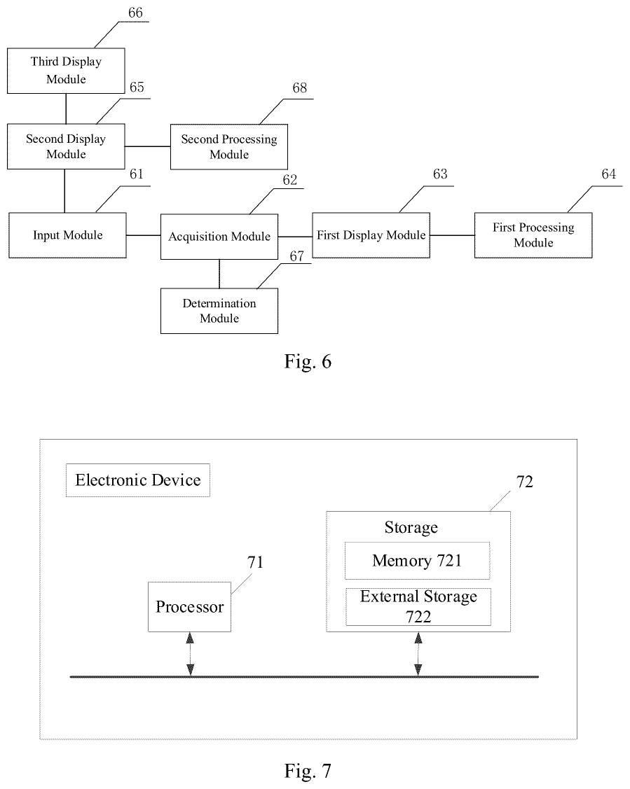

FIG. 6 is a schematic diagram of an apparatus for question-and-answer processing according to an embodiment of the present disclosure, the apparatus includes:
an input module 61 which is configured to receive a content of a first to-be-processed question that is inputted;
an acquisition module 62 which is configured to acquiring at least two first answer results of the content of the first to-be-processed question, where the at least two first answer results are generated based on at least two target generative models matched with the content of the first to-be-processed question respectively, the at least two target generative models are capable of answering the first to-be-processed question, and generative models of different types are trained based on different occupational scenes; and
a first display module 63 which is configured to display the at least two first answer results.

In an optional embodiment, when displaying the at least two first answer results, the first display module 63 is configured to:
display label identifiers respectively representing the at least two target generative models,
wherein for each label identifier of the label identifiers, a display card corresponding to the label identifier is used for displaying a first answer result generated by a target generative model corresponding to the label identifier; and
in response to a switching operation for a first label identifier among the label identifiers, switch to display a first answer result generated by a target generative model corresponding to the first label identifier.

In an optional embodiment, when displaying the at least two first answer results, the first display module 63 is further configured to:
for a first answer result among the at least two first answer results, display question prompt information associated with the first answer result; and
in response to a selection operation for the question prompt information, acquire an adjusted first answer result, and displaying the adjusted first answer result, where the adjusted first answer result is obtained by a target generative model corresponding to the first answer result adjusting the first answer result according to the question prompt information selected.

In an optional embodiment, the apparatus further includes a first processing module 64 which is configured to execute the following steps after displaying the at least two first answer results:
in response to a dialogue instruction of a first target generative model selected from the at least two target generative models, jump to display a first chat interface associated with the first target generative model;
receive a content of a second to-be-processed question that is inputted in the first chat interface; and
acquire a second answer result for the content of the second to-be-processed question, where the second answer result is generated by the first target generative model performing semantic analysis based on an occupational scene guide language associated with the first target generative model and the content of the second to-be-processed question.

In an optional embodiment, before receiving the content of the first to-be-processed question that is inputted, the apparatus further includes a second display module 65 which is configured to:
display a plurality of virtual images respectively representing the generative models of different types, where the plurality of virtual images are related to occupational scenes associated with the generative models;
in response to a selection operation for a first virtual image among the plurality of virtual images, display a second chat interface associated with the first virtual image, and receive the content of the first to-be-processed question that is inputted in the second chat interface, where the first virtual image is associated with a generative model trained based on a comprehensive occupational scene; or, in response to the selection operation for the first virtual image among the plurality of virtual images, highlight the first virtual image, and in response to an input instruction, receive the content of the first to-be-processed question that is inputted.

In an optional embodiment, the second display module 65 is further configured to:
in a form of a plurality of functional cards combined, display the plurality of functional cards, wherein the plurality of functional cards are used for displaying corresponding functional information respectively; and
in response to a switching operation for a functional card among the plurality of functional cards, switch to display functional information corresponding to the functional card,
where the functional card includes a historical dialog functional card and a question asking functional card, the historical dialog functional card displays historical question-and-answer information, and the question asking functional card displays the plurality of virtual images.

In an optional embodiment, the apparatus further includes a third display module 66 which is configured to: in response to a detail introduction view operation for a virtual image in the plurality virtual images, display an information card of the virtual image, and display detail introduction information of the virtual image in the information card.

In an optional embodiment, the apparatus further includes a determination module 67, and the target generative model is determined by the determination module 67 through the following mode:
performing intention recognition on the content of the first to-be-processed question and obtaining a target intention category of the content of the first to-be-processed question, where the target intention category represents an intention category of an occupational scene required for answering the first to-be-processed question; and
according to the target intention category and occupational scene feature information associated with the generative models, matching the target intention category with each piece of occupational scene feature information, and determining the target generative model which meets a similarity condition from the generative models.

In an optional embodiment, the apparatus further includes a second processing module 68 which is configured to:
in response to a selection operation for a second virtual image among the plurality of virtual images, display a third chat interface associated with the second virtual image, and receive the content of a third to-be-processed question inputted in the third chat interface, where the second virtual image is associated with a generative model trained based on an occupational scene;
acquire a third answer result for the content of the third to-be-processed question, where the third answer result is generated by the generative model associated with the second virtual image; and
display the third answer result in the third chat interface.

The description of the processing flow of each module in the apparatus and the description of the interaction flow between the modules can refer to the related description in the embodiments of the method, which are not repeated here.

An embodiment of the present disclosure further provides an electronic device. FIG. 7 is a structural schematic diagram of an electronic device according to an embodiment of the present disclosure, and the electronic device includes:
at least one processor 71 and at least one storage 72; the storage 72 stores machine readable instructions executable by the processor 71; the processor 71 is configured to execute the machine readable instructions stored in the storage 72; when the machine readable instructions are executed by the processor 71, the processor 71 is configured to execute the following steps:
receiving a content of a first to-be-processed question that is inputted;
acquiring at least two first answer results of the content of the first to-be-processed question, where the at least two first answer results are generated based on at least two target generative models matched with the content of the first to-be-processed question respectively, the at least two target generative models are capable of answering the first to-be-processed question, and generative models of different types are trained based on different occupational scenes; and
displaying the at least two first answer results.

The storage 72 includes a memory 721 and an external storage 722; the memory 721 is also called an internal storage and is configured to temporarily store operation data in the processor 71, and data exchanged with an external storage 722 such as a hard disk, and the processor 71 exchanges data with the external storage 722 through the memory 721.

The specific execution process of the instruction can refer to the steps of the method for question-and-answer processing according to embodiment of the present disclosure, which is not repeated here.

An embodiment of the present disclosure further provides a computer-readable storage medium storing computer programs, and the computer programs upon being run by at least one processor, execute the steps of the method for question-and-answer processing described in the above method embodiment. The storage medium may be a volatile or nonvolatile computer-readable storage medium.

An embodiment of the present disclosure further provides a computer program product carrying program codes, the program codes including instructions that can be used to execute the steps of the method for question-and-answer processing described in the above-mentioned method embodiment. For details, please refer to the above-mentioned method embodiment, and the details are not repeated here.

The computer program product may be specifically implemented by hardware, software or a combination thereof. In one alternative embodiment, the computer program product is embodied as a computer storage medium, and in another alternative embodiment, the computer program product is embodied as a software product, such as a software development kit (SDK) and the like.

It can be clearly understood by those skilled in the art that, for convenience and simplicity of description, specific working processes of the system and the apparatus described above may refer to the corresponding processes in the foregoing method embodiment, which are omitted here. In the several embodiments provided in the present disclosure, it is to be understood that the disclosed system, apparatus, and method may be implemented in other manners. The above-described apparatus embodiments are merely illustrative. For example, the division of the units may be merely a logical function division, and in actual implementation, there may be another division mode. For another example, multiple units or components may be combined or integrated into another system, or some features may be omitted, or may not be executed. In addition, the displayed or discussed mutual couplings or direct couplings or communication connections may be implemented through some communication interfaces. The indirect couplings or communication connections between the apparatuses or units may be implemented in electronic, mechanical, or other forms.

The units described as separate parts may or may not be physically separate, and the components displayed as units may or may not be physical units, that is, they may be located in one position, or may be distributed on a plurality of network units. Some or all of the units may be selected according to actual needs to achieve the purposes of the solutions of the embodiments.

In addition, functional units in the embodiments of the present disclosure may be integrated into one processing unit, or each unit may exist alone physically, or two or more units may be integrated into one unit.

The functions, if implemented in software functional units and sold or used as a stand-alone product, may be stored in a nonvolatile computer-readable storage medium executable by a processor. Based on such understanding, the technical solutions of the present disclosure, which are essential or part of the technical solutions contributing to the related art, may be embodied in the form of a software product, which software product is stored in a storage medium and includes several instructions for causing a electronic device (which may be a personal computer, a server, or a network device, etc.) to execute all or part of the steps of the methods described in the embodiments of the present disclosure. The aforementioned storage medium includes a U disk, a mobile hard disk, a read-only memory (ROM), a random access memory (RAM), a magnetic disk or an optical disk and other media that can store program codes.

Finally, it should be noted that the above-mentioned embodiments are merely specific embodiments of the present disclosure, which are used to illustrate the technical solutions of the present disclosure, but not to limit the technical solutions, and the scope of protection of present disclosure is not limited thereto. Although the present disclosure is described in detail with reference to the foregoing embodiments, those of ordinary skill in the art should understand that any person familiar with the art can still make modifications or changes to the embodiments described in the foregoing embodiments, or make equivalent replacements for some of the technical features, within the technical scope of the present disclosure; and such modifications, changes or replacements do not make the essence of the corresponding technical solution deviate from the spirit and scope of the technical solutions of the embodiments of the present disclosure, and should be included in the scope of protection of the present disclosure. Therefore, the scope of protection of the present disclosure shall be subject to the scope of protection of the appended claims.

1. A method for question-and-answer processing, comprising:
receiving a content of a first to-be-processed question that is inputted;
acquiring at least two first answer results of the content of the first to-be-processed question, wherein the at least two first answer results are generated based on at least two target generative models matched with the content of the first to-be-processed question respectively, the at least two target generative models are capable of answering the first to-be-processed question, and generative models of different types are trained based on different occupational scenes; and
displaying the at least two first answer results.

2. The method according to claim 1, wherein the displaying the at least two first answer results comprises:
displaying label identifiers respectively representing the at least two target generative models,
wherein for each label identifier of the label identifiers, a display card corresponding to the label identifier is used for displaying a first answer result generated by a target generative model corresponding to the label identifier; and
in response to a switching operation for a first label identifier among the label identifiers, switching to display a first answer result generated by a target generative model corresponding to the first label identifier.

3. The method according to claim 1, when displaying the at least two first answer results, further comprising:
for a first answer result among the at least two first answer results, displaying question prompt information associated with the first answer result; and
in response to a selection operation for the question prompt information, acquiring an adjusted first answer result, and displaying the adjusted first answer result,
wherein the adjusted first answer result is obtained by a target generative model corresponding to the first answer result adjusting the first answer result according to the question prompt information selected.

4. The method according to claim 2, after displaying the at least two first answer results, further comprising:
in response to a dialogue instruction of a first target generative model selected from the at least two target generative models, jumping to display a first chat interface associated with the first target generative model;
receiving a content of a second to-be-processed question that is inputted in the first chat interface; and
acquiring a second answer result for the content of the second to-be-processed question, wherein the second answer result is generated by the first target generative model performing semantic analysis based on an occupational scene guide language associated with the first target generative model and the content of the second to-be-processed question.

5. The method according to claim 1, before receiving a content of a first to-be-processed question that is inputted, further comprising:
displaying a plurality of virtual images respectively representing the generative models of different types, wherein the plurality of virtual images are related to occupational scenes associated with the generative models;
in response to a selection operation for a first virtual image among the plurality of virtual images, displaying a second chat interface associated with the first virtual image, and receiving the content of the first to-be-processed question that is inputted in the second chat interface, wherein the first virtual image is associated with a generative model trained based on a comprehensive occupational scene; or
in response to the selection operation for the first virtual image among the plurality of virtual images, highlighting the first virtual image, and in response to an input instruction, receiving the content of the first to-be-processed question that is inputted.

6. The method according to claim 5, further comprising:
in a form of a plurality of functional cards combined, displaying the plurality of functional cards, wherein the plurality of functional cards are used for displaying corresponding functional information respectively; and
in response to a switching operation for a first functional card among the plurality of functional cards, switching to display functional information corresponding to the first functional card,
wherein the functional card comprises a historical dialog functional card and a question asking functional card, the historical dialog functional card displays historical question-and-answer information, and the question asking functional card displays the plurality of virtual images.

7. The method according to claim 5, further comprising:
in response to a detail introduction view operation for a virtual image in the plurality virtual images, displaying an information card of the virtual image, and displaying detail introduction information of the virtual image in the information card.

8. The method according to claim 1, wherein each target generative model of the at least two target generative models is determined by:
performing intention recognition on the content of the first to-be-processed question and obtaining a target intention category of the content of the first to-be-processed question, wherein the target intention category represents an intention category of an occupational scene required for answering the first to-be-processed question; and
according to the target intention category and occupational scene feature information associated with the generative models, matching the target intention category with each piece of occupational scene feature information, and determining the target generative model which meets a similarity condition from the generative models.

9. The method according to claim 5, further comprising:
in response to a selection operation for a second virtual image among the plurality of virtual images, displaying a third chat interface associated with the second virtual image, and receiving the content of a third to-be-processed question inputted in the third chat interface, wherein the second virtual image is associated with a generative model trained based on an occupational scene;
acquiring a third answer result for the content of the third to-be-processed question, wherein the third answer result is generated by the generative model associated with the second virtual image; and
displaying the third answer result in the third chat interface.

10. An electronic device, comprising:
at least one processor and at least one storage, wherein the at least one storage stores computer-readable instructions executable by the at least one processor; the at least one processor is configured to execute the computer-readable instructions stored in the at least one storage, the at least one processor upon executing the computer-readable instructions, implements a method for question-and-answer processing, and the method comprises:
receiving a content of a first to-be-processed question that is inputted;
acquiring at least two first answer results of the content of the first to-be-processed question, wherein the at least two first answer results are generated based on at least two target generative models matched with the content of the first to-be-processed question respectively, the at least two target generative models are capable of answering the first to-be-processed question, and generative models of different types are trained based on different occupational scenes; and
displaying the at least two first answer results.

11. The electronic device according to claim 10, wherein the displaying the at least two first answer results comprises:
displaying label identifiers respectively representing the at least two target generative models,
wherein for each label identifier of the label identifiers, a display card corresponding to the label identifier is used for displaying a first answer result generated by a target generative model corresponding to the label identifier; and
in response to a switching operation for a label identifier among the label identifiers, switching to display a first answer result generated by a target generative model corresponding to the label identifier.

12. The electronic device according to claim 10, wherein when displaying the at least two first answer results, the method further comprises:
for a first answer result among the at least two first answer results, displaying question prompt information associated with the first answer result; and
in response to a selection operation for the question prompt information, acquiring an adjusted first answer result, and displaying the adjusted first answer result,
wherein the adjusted first answer result is obtained by a target generative model corresponding to the first answer result adjusting the first answer result according to the question prompt information selected.

13. The electronic device according to claim 11, wherein after displaying the at least two first answer results, the method further comprises:
in response to a dialogue instruction of a first target generative model selected from the at least two target generative models, jumping to display a first chat interface associated with the first target generative model;
receiving a content of a second to-be-processed question that is inputted in the first chat interface; and
acquiring a second answer result for the content of the second to-be-processed question, wherein the second answer result is generated by the first target generative model performing semantic analysis based on an occupational scene guide language associated with the first target generative model and the content of the second to-be-processed question.

14. The electronic device according to claim 10, wherein before receiving a content of a first to-be-processed question that is inputted, the method further comprises:
displaying a plurality of virtual images respectively representing the generative models of different types, wherein the plurality of virtual images are related to occupational scenes associated with the generative models;
in response to a selection operation for a first virtual image among the plurality of virtual images, displaying a second chat interface associated with the first virtual image, and receiving the content of the first to-be-processed question that is inputted in the second chat interface, wherein the first virtual image is associated with a generative model trained based on a comprehensive occupational scene; or
in response to the selection operation for the first virtual image among the plurality of virtual images, highlighting the first virtual image, and in response to an input instruction, receiving the content of the first to-be-processed question that is inputted.

15. The electronic device according to claim 14, wherein the method further comprises:
in a form of a plurality of functional cards combined, displaying the plurality of functional cards, wherein the plurality of functional cards are used for displaying corresponding functional information respectively; and
in response to a switching operation for a functional card among the plurality of functional cards, switching to display functional information corresponding to the functional card,
wherein the functional card comprises a historical dialog functional card and a question asking functional card, the historical dialog functional card displays historical question-and-answer information, and the question asking functional card displays the plurality of virtual images.

16. The electronic device according to claim 14, wherein the method further comprises:
in response to a detail introduction view operation for a virtual image in the plurality virtual images, displaying an information card of the virtual image, and displaying detail introduction information of the virtual image in the information card.

17. The electronic device according to claim 10, wherein each target generative model of the at least two target generative models is determined by:
performing intention recognition on the content of the first to-be-processed question and obtaining a target intention category of the content of the first to-be-processed question, wherein the target intention category represents an intention category of an occupational scene required for answering the first to-be-processed question; and
according to the target intention category and occupational scene feature information associated with the generative models, matching the target intention category with each piece of occupational scene feature information, and determining the target generative model which meets a similarity condition from the generative models.

18. The electronic device according to claim 14, wherein the method further comprises:
in response to a selection operation for a second virtual image among the plurality of virtual images, displaying a third chat interface associated with the second virtual image, and receiving the content of a third to-be-processed question inputted in the third chat interface, wherein the second virtual image is associated with a generative model trained based on an occupational scene;
acquiring a third answer result for the content of the third to-be-processed question, wherein the third answer result is generated by the generative model associated with the second virtual image; and
displaying the third answer result in the third chat interface.

19. A non-transient computer-readable storage medium, storing computer programs, wherein the computer programs, upon being executed by at least one processor, implement a method for question-and-answer processing, and the method comprises:
receiving a content of a first to-be-processed question that is inputted;
acquiring at least two first answer results of the content of the first to-be-processed question, wherein the at least two first answer results are generated based on at least two target generative models matched with the content of the first to-be-processed question respectively, the at least two target generative models are capable of answering the first to-be-processed question, and generative models of different types are trained based on different occupational scenes; and
displaying the at least two first answer results.
